(19) United States
(12) Patent Application Publication
(10) Pub. No.: US 2003/0169205 A1
(43) Pub. Date: Sep. 11, 2003

(54) Modular printed antenna

(76) Inventors: Daniel J. Gioia, Streamwood, IL (US); Robert G. Uskali, Schaumburg, IL (US); Peter A. Kindinger, Cary, IL (US)

Correspondence Address: MOTOROLA, INC., 1303 EAST ALGONQUIN ROAD, IL01/3RD, SCHAUMBURG, IL, 60196

(21) Appl. No.: 10/093,877

(22) Filed: Mar. 8, 2002

(51) Int. Cl. H01Q 1/24

(52) U.S. Cl. 343/702; 343/906

(57) ABSTRACT

An interchangeable and modular antenna 10 in a wireless communications device 30 that is configured for RF wireless communications based on one of a plurality of different predetermined RF communication protocols. The wireless communications device 30 allows multiple antenna modules 10 to be provided for being selected for use in the communications device 3. The communications device 30 includes a radio module 34 and a main circuit board 32 having an electrical connector 40. One or more antenna modules 10 are releasably mounted on the main circuit board 32 of the radio module 34 using a mating RF connector 24 that engages the radio module's electrical connector 40 to enable a cable-free and interchangeable connection of the radio module 34 with the antenna module 10.

### FIELD OF THE INVENTION

The present invention relates generally to antenna systems used in radio communication and, more particularly, to modular antennas.

### BACKGROUND OF THE INVENTION

Traditionally, antennas have been available in many forms and sizes ranging from small modular external antennas extending visibly from the backs of portable radios to large parabolic dishes mounted on rooftops. Until recently, and particularly in the case of modular extended antennas, an installer or customer was able to change the operating characteristics of a communications device by replacing the installed antenna with another one that is selected from a wide range of available antennas having different characteristics.

However, as available frequency spectrums become increasingly scarce and as different devices and communications methods share the same frequency band, the use of easily changeable antennas has become increasingly restricted. In particular, the Federal Communications Commission (FCC) presently prohibits communications devices from having antennas assemblies that are easily changed by a user. This prevents the user from either purposefully or inadvertently using an antenna system on a device to exceed the allowed peak radiated power, thereby also preventing one class of devices in a particular frequency band from interfering with another class of devices in the same frequency band.

For example, recently developed consumer products have been developed for operation in higher frequency bands, such as in the 2.4 GHz ISM (industrial, scientific, medical) band. Telephones, Bluetooth enabled products, several types of wireless local area networking systems and other devices all share the same 2.4 Ghz spectrum, thereby requiring different radio transceivers for the same frequency band. To minimize interference between these devices, antennas that do not exceed peak power specifications must be used. In addition, different radio device installations in a home or an office may require different RF performances. Accordingly, the usual approach is to provide modularity of a communication system by separate radio and antenna elements connected with an RF cable assembly, which enables different antennas to be plugged in the back end assembly of the radio devices. The problem with such an approach is the high cost of RF cables and connectors, which can be about 75-90% of the total system cost.

Because of the inherent nature of RF signals and antennas, devices operating at higher frequency bands are able to utilize smaller and less expensive antennas that can be integrated inside the product housing of the communications device. In addition, not only are high frequency devices able to operate using physically smaller antennas, but the design of antennas also has been improved greatly by making them as compact as possible using a new concept of patch antennas called “printed circuit antennas.”

In addition to its light weight, a substantially planar printed circuit antenna has the advantage of being able to be formed at the same time and on the same substrate as other circuit sections. This reduces the manufacturing time and cost of the product. However, because the antenna design is no longer separate from the radio device, it is unable to provide the benefits of modularity.

### SUMMARY OF THE INVENTION

In accordance with an aspect of the present invention, an interchangeable and modular antenna system in a wireless communications device is provided. The wireless communication circuitry is preferably configured for RF wireless communications based on one of a plurality of different predetermined RF communication protocols. Antenna modules are selected for use with the device based on the predetermined performance characteristics of the antenna module that are optimized for the RF communication protocol employed via the RF wireless communication circuitry. The wireless communication device allows multiple modules to be provided for being selected for use in the device. Each RF module houses a RF wireless communication circuitry based on a different RF communication protocol and an associated circuit board.

The antenna module, which comprises a printed circuit antenna, includes keyhole slots and alignment cuts that are designed to engage support posts on the communications device to enable the modular antenna board to be easily placed into position and just as easily removed by an end user or manufacturer. The support posts position and hold the antenna module securely at the precise height such that the connector on the antenna module is coupled to the antenna connector on the radio or RF module of the communications device. Thus a particular advantage of the antenna module is the ability to quickly change the operating characteristics of the communications device by simply removing and installing antenna modules.

An additional advantage of the antenna module is that the low manufacturing cost of the module allows a manufacturer to include several antenna modules with each communications device, wherein each antenna module includes a standard connector or interface for connecting to the radio module. In addition, each antenna module has different performance characteristics, such as radiation pattern, bandwidth and power requirements. For example, one module may be optimized for a multilevel home or office building and provides a first antenna module that is configured with an omni-directional antenna for broad coverage. The second module may be optimized for a single level house and have a directional antenna pattern in only one plane. Thus, the user is provided the flexibility to tailor the communication device's operating characteristics by simply changing one antenna module out for another.

In another aspect of the invention, the radio module of the communication device is also modular and easily interchangeable. As with the antenna modules, each of the radio modules includes the same type of connector for coupling with the antenna modules. Thus, a manufacturer or user of these devices is able to produce, for example, a Bluetooth device or a HomeRF device by simply installing the appropriate radio module into the communication device, while leaving the rest of the device in its original configuration. As discussed, the radio modules are configured with the same standard interface so as to use the same antenna modules, thereby resulting in increased cost savings and flexibility.

### BRIEF DESCRIPTION OF THE DRAWINGS

FIG. 1 is a perspective view of an antenna module in accordance with the present invention showing a circuit board having a printed antenna circuit and an electrical connector integrated thereon;

FIG. 2 is a perspective view of a circuit board assembly for a wireless communication device showing three different FIG. 1 antenna modules;

FIG. 3 is a perspective view of the main circuit board assembly of FIG. 2 showing two of the antenna modules releasably connected thereto;

FIG. 4 is an elevational view of an electrical connector of the antenna module; and

FIG. 5 is a plain view of an antenna module with an omni directional pattern.

### DETAILED DESCRIPTION OF THE EMBODIMENTS

Referring to FIG. 1 and FIG. 5, there is illustrated a modular antenna 10 in accordance with the present invention having a surface mounted connector 24, keyhole slots 28 and mounting elements 26 for enabling one or more modular antennas to be releasably and interchangeably mounted on a wireless communications device having a corresponding mating connector and mounting posts.

The antenna module 10 includes an antenna circuit board 20 having a thin body with printed antenna circuit 22 on at least one surface of the body, and a low profile surface mount RF male connector 24, which does not significantly increase the effective thickness of the circuit board. For example, the antenna module of the present embodiment is 50.8″×19″, with thickness of the body of about 1.6″. The male connector 24 is mounted sideways on the edge of the antenna board by soldering its three pins to antenna circuit 22 to provide electrical connections of the antenna and enable wireless communication of the antenna module 10 to a communication device. The antenna circuit board may be releasably mounted in a desired location by any suitable means. In the preferred embodiment, the antenna circuit board 20 comprises a pair of mounting elements 26 (alignment cuts) and a pair of keyhole-shaped mounting elements 28 to securely position the antenna module 10 on a predetermined surface within a communication device having matching mounting elements.

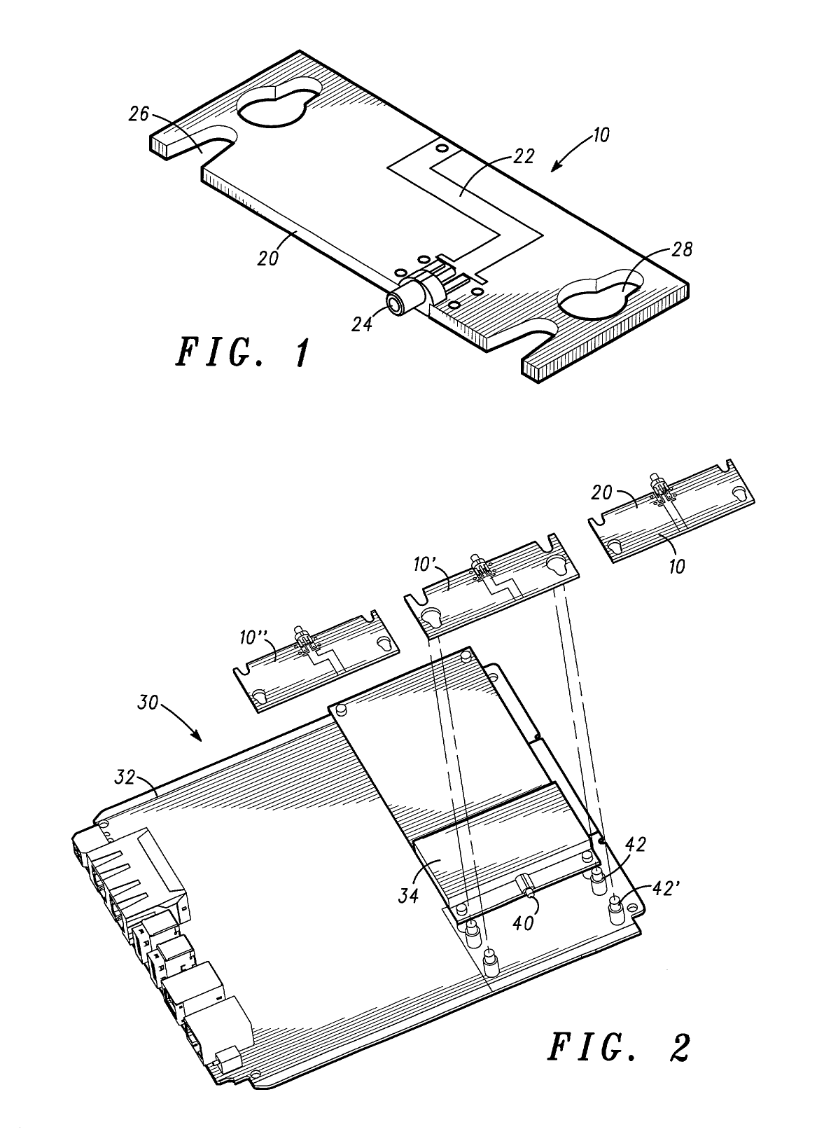

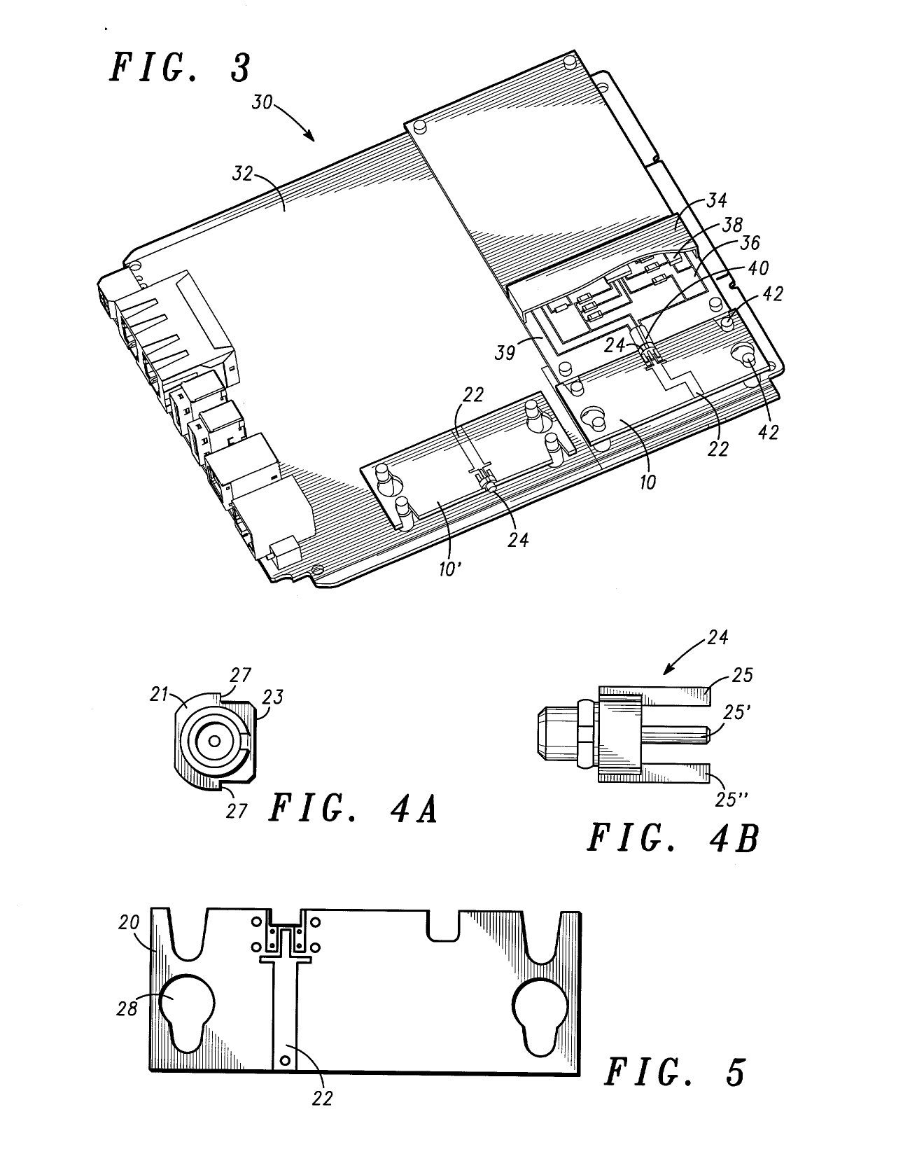

The mounting elements on the PCB are support posts 42 and 42′ (FIG. 2) having supporting shoulders for installation of the module boards. The antenna module 10 is positioned on the shoulders of the support posts 42′ so that the wider part of the keyhole is located over the posts 42′, level with the support post shoulders, and the edges of the cuts 26 are on the shoulder of the support posts 42. In this manner, the male connector 24 of the antenna module 10 is positioned at a height level with the female connector 40 of the RF module. The antenna module 10 then is moved forward so that the connectors 24 and 40 mate. The mating connectors 24 and 40 may be MMCX surface mount 3-pins connectors such as MOLEX #73415-099X as shown in FIG. 4, or any other available surface mount connectors that do not increase significantly the thickness of the circuit board.

After installation, the first set of support posts 42 are positioned within the semi-circular cuts 26 and the second set of support posts 42′ are located within the narrow portions of the keyhole slots 28. For added stability, the keyhole slot 28 may be sized such that when the antenna module 10 is moved forward, the narrow portion of the keyhole slot 28 tightly engages the support post 42′.

Mounting elements 26, which are alignment cuts, advantageously serve a dual purpose. First, the mounting elements 26 assist in the mounting of the antenna module 10 to the communication device 30 by positioning the board into a correct alignment. When the antenna board 10 is moved forward, the mounting elements 26 force the antenna board 10 into position such that the male connector 24 aligns properly with the female connector 40, thereby eliminating any stress on the connectors from misaligned attempts at connecting. Second, the mounting elements 26, being alignment cuts, also enhance the stability and support of the antenna board 10 when in its mounted position. Using alignment cuts at the front of the antenna board 10 instead of, for example, a keyhole slot or oval, enables the support posts 42 to be placed closer to the radio module. This allows the antenna board 10 to be positioned such that is supported at its furthermost corners, thereby reducing the possibility of stressing the board and creating forces on the relatively fragile male and female connectors when the antenna module is connected to the communication device 30.

It is to be noted that in actual operation, the communications device 30 is located within a housing (not shown) in which the main circuit board 32 is mounted in such a way as to allow insertion and removal of the antenna module 10 at the back end assembly with the antenna connector 24 being easily connected to and disconnected from the radio module connector 40.

Thus, a particular advantage of using the keyhole slot and support post system of mounting the antenna module 10 is the ease in which the antenna boards 10 may be installed and removed by an end user. As a user's requirement for the type of wireless communication standard being used varies, only two to three simple operations are needed to change the antenna board to make the device compatible with an alternate communications standard. The keyhole and support post system of mounting also simplifies machine installation of the antenna boards 10. Further, because of the tight fit between the narrow portion of the keyhole slot 28 and the support post 42, bumping or jarring of the unit will not cause the antenna module 10 to become disconnected.

Turning to FIG. 3, there is shown a circuit board assembly for the wireless communication device 30. The device 30 provides a module assembly including an RF communication module, or radio module 34 and one or more antenna modules 10 releasably mounted on a main circuit board 32. The radio module 34 comprises wireless communication circuitry 36 on an associated circuit board 38, and a surface mount electrical connector 40 electrically connected to the circuitry 36, for example, by soldering, and mating with the male antenna connector 24 as described above, which allows a cable-free connection of the radio module 34 with the antenna module 10. The main circuit board 32 of the device 30 is provided with support posts 42 and 42′ for releasably mounting an antenna module 10 in a predetermined position adjoining the radio module 34 as described above.

Also shown is the cable-free electrical connection of the radio module circuitry 36 with the antenna 22, when the antenna module 10 is mounted on the main circuit board 32 of the device 20 by means of matching mounting elements. The antenna module 10 and the communication module 30 are mechanically and electrically coupled to one another by mating RF connectors 24 and 40. The pins 25, 25′ and 25″ of the male connector 24 are soldered to the antenna circuit 22 and the pins of the female connector 40 are soldered to the circuit of the radio module 34. The male and female connectors are soldered to their respective boards in such a position that when the antenna module 10 is mounted into position, the male connector 24 and the female connector 40 are oriented opposite each other and in a position to be coupled. As shown in FIG. 4, the male connector 24 is configured to include connector head 21, having shoulders 27 and 27′ and a flat base portion 23. This configuration enables the connector 24 to be installed onto the antenna module 10 in a manner such that the base portion 23 of the connector 24 sits flush with the circuit board 20 of the antenna module.

Referring now to FIG. 5, there is shown by way of example an antenna module 10 that is optimized for HOME RF standard with a substantially omni directional antenna pattern 22 printed thereon. When the antenna module 10 is installed within the device housing, it provides a directional pattern upward but does not provide a downward pattern. This module is optimized for installation on the middle or lower level of a house and therefore would not provide optimized performance when installed in the attic or in a corner of the house. However, by simply exchanging the installed antenna module with another appropriate module, the device is quickly and easily configured for optimal performance in the attic or a corner of the house. The antenna modules also may be optimized for desktop, ceiling or wall installation. The user is thus able to easily change the antenna module to optimize the performance characteristics of the device in accordance with the operating requirements and the position of the device. In a manufacturing setting, the antenna module 10, in the present embodiment, is mounted to the communications device 30 during the back end assembly of the device to facilitate ease of manufacture. Thus, a plurality of antenna modules is available at the assembly site such that the antenna module is selected by the manufacturer of the device based on the particular RF communication protocol employed by the device.

In order to further optimize the performance of the communications device, in another embodiment the antenna modules are combined to obtain the necessary performance characteristics. Thus, the antenna modules 10 and 10′ shown in FIG. 3 maybe electrically connected together by a cable to provide combined performance characteristics for the device. Also, the modules may be installed one above another, supported by isolating spacers and electrically coupled to one another in series by means of a connector. Cost savings also may be realized through the use of combined antenna modules as well. By combining antenna modules to provide unique performance characteristics, the requirement for an extra module providing the combined characteristic is eliminated.

In yet another embodiment, the modular structure of the communication device enables the use of different radio modules with the group of antenna modules included in a package. The radio module 34 is releasably mounted on the main circuit board 32 of the communications device 30 and may be exchanged for another radio module having the ability to mate with the antenna modules 10 included in the package. The connector 40 is mounted on the circuit board 38 of the radio module 34 and, upon installation of the radio module, is electrically connected to the main circuit board 32 of the communications device 30. Subsequently, a selected antenna module 10 is mounted into position as described above and the connector 24, which is electrically connected to the antenna 22, couples with the connector 40. Thus, a particular communications protocol may easily and quickly be selected. For example, in the 2.4 GHZ band there are three standards that may be used for home networking. The radio modules or transceivers for each of the standards, including Bluetooth, HomeRF and 802.11b, may be used with the same antennas, as described above. Therefore, the present invention provides a standard interface between the radio and antenna modules.

A particular advantage of interchangeable radio devices is the flexibility provided to an end user. For example, a user may wish to move a laptop between his office and home. If the user has an 802.11b type transceiver, which is generally intended for use in an office-type environment, it will not be compatible with his home HomeRF system. The user then, once at home, is forced to either use a wired connection to the network through an Ethernet connection or the like or to install a HomeRF adapter into the notebook, which requires the user to own and maintain multiple communication devices. In accordance with the present invention, however, the user simply is able to remove the 802.11b transceiver and replace it with the HomeRF transceiver. All other parts of the device remain as originally configured. Thus, the user is able to quickly and inexpensively switch between communication protocols. Furthermore, as described above, the user may then choose to change the antenna module 10 depending on where the laptop is being used. By providing a wireless connection between the radio and antenna modules and eliminating the cost of a separate RF coax cables previously required for this level of flexibility, significant cost savings are realized.

Therefore, it is clear that the user is provided an increased level of flexibility through the use of the interchangeable radio and antenna modules. In fact, a kit having two radio modules and two antenna modules enables the end user to have up to six configuration options. The standard interface between the radio and antenna modules further enables the user to rapidly switch out components as necessary and set up the required configuration quickly and easily.

Although the present invention has been described with reference to the preferred embodiments, it will be appreciated that the invention is not limited to the details described thereof and numerous changes and modifications will occur to those skilled in the art, and it intended in the appended claims to cover all those changes and modifications which fall within the true spirit and scope of the present invention.

What is claimed is:

1. An antenna for receiving airborne signals for an electronic device having circuitry adapted to allow for wireless communications with the device, the antenna comprising:
an antenna circuit board having predetermined compact dimensions for space conservation upon connection to the device;
an antenna circuit on the circuit board that defines predetermined performance characteristics for the antenna; and
an electrical connector on the circuit board to allow the board to be releasably connected to the device with the antenna circuit electrically connected to the device circuitry without the need for a cable between the antenna board and the device to establish the electrical connection between the circuits.

2. The antenna of claim 1 wherein the predetermined performance characteristics include the radiation pattern, bandwidth and power requirements for the antenna.

3. The antenna of claim 1 wherein the circuit board has a thin body and opposite surfaces on the body with the antenna circuit formed on at least one of the board surfaces, and the electrical connector comprises a low profile surface mount connector on the body that does not significantly increase an effective thickness of the thin body.

4. The antenna of claim 1 wherein the antenna circuit is an RF antenna circuit and the electrical connector is an RF electrical connector.

5. The antenna of claim 1 wherein the antenna circuit is configured for transmitting airborne signals for the device.

6. A wireless communication device comprising:
circuitry of the device configured for enabling wireless communications with the device;
an electrical connector of the device that is electrically connected to the wireless communication circuitry;
a plurality of antenna modules each comprising a circuit board having an antenna circuit for receiving airborne signals for the device and having different predetermined performance characteristics from each other; and
an electrical connector integrated into each of the modules, the electrical connector having the same predetermined configuration on each of the modules and adapted to frictionally engage the device electrical connector for electrically connecting the antenna circuit to the wireless communication circuitry and to be disengaged therefrom to allow the modules to be selectively interchanged based on the associated performance characteristics thereof.

7. The wireless communication device of claim 6 wherein the different predetermined performance characteristics tailor use of each of the modules to different predetermined operating environments for the device.

8. The wireless communication device of claim 6 wherein the wireless communication circuitry includes an RF module and a main circuit board to which the RF module is releasably attached to allow different RF modules to be connected to the circuit board, each having the communication circuitry thereof configured for different RF protocols, and the device electrical connector is disposed on the main circuit board.

9. The wireless communication device of claim 6 whereas the device includes a circuit board, and the electrical connectors are edge connectors formed integrally onto the edge of the device and antenna circuit boards.

10. The wireless communication device of claim 9 including a housing having mounting members to which the main circuit board is mounted and which orient the electrical connector of the antenna module in position for being mechanically connected to the device electrical connector.

11. The wireless communication device of claim 9 including a housing in which the electrical connectors and circuit boards are situated with one of the antenna modules connected to the device electrical connector.

12. The wireless communication device of claim 9 wherein the wireless communication circuitry is configured for RF wireless communications based on one of a plurality of different predetermined RF communication protocols, and the antenna modules are selected for use with the device based on the antenna module having the predetermined performance characteristics that are optimized for the RF communication protocol employed via the RF wireless communication circuitry.

13. The wireless communication device of claim 12 including an RF module housing the RF wireless communication circuitry and the associated circuit board to allow multiple modules to be provided each with RF circuitry based on the different RF communication protocols for being selected for use in the device.

14. The wireless communication device of claim 6 wherein the electrical connectors are RF surface mount connectors.

15. A method for optimizing operation of a wireless communication device, the method comprising:
providing a plurality of antenna modules each with different performance characteristics;
selecting one of the antenna modules for use with the device based on the performance characteristics thereof; and
releasably connecting the selected one of the antenna modules to wireless communication circuitry of the device for receiving airborne signals for the device.

16. The method of claim 15 wherein the plurality of antenna modules are provided by packaging the modules for sale with the device for which the modules are to be used with the antenna module being selected by a purchaser or user of the device and the modules packaged therewith.

17. The method of claim 16 wherein the purchaser or user selects the antenna module by determining an environment of use of the device and selecting the module having characteristics optimized for the device's use environment.

18. The method of claim 15 wherein the plurality of antenna modules are provided by maintaining the modules available at an assembly location of the device with the antenna module being selected by a manufacturer of the device.

19. The method of claim 18 wherein the manufacturer selects the antenna module by determining an RF communication protocol utilized by the device wireless communication circuitry and selecting the module having performance characteristics optimized for the RF communication protocol employed.

20. The method of claim 15 wherein the antenna module is releasably connected to the wireless communication circuitry by mating surface mount RF electrical connectors of the device and the module together.

21. The method of claim 15 wherein the wireless communication circuitry is on a circuit board in a communication module, and the selected antenna module is releasably connected to the wireless communication circuitry by:
providing a main circuit board of the device with an electrical connector;
providing a plurality of the communication modules each having the communication circuitry therein based on different wireless communication protocols,
selecting one of the communication modules for use with the device,
mounting the selected communication module to the main circuit board electrically connected to the electrical connector thereof, and
mating an electrical connector of the antenna module with the electrical connector of the main printed circuit board.
